(19) United States
(12) Patent Application Publication
(10) Pub. No.: US 2026/0083071 A1
(43) Pub. Date: Mar. 26, 2026

(54) AIR BLOWING DEVICE

(71) Applicant: JIANGSU DONGCHENG TOOLS TECHNOLOGY CO., LTD., Nantong (CN)

(72) Inventors: Qiang Ji, Nantong (CN); Gongyuan Fan, Nantong (CN)

(21) Appl. No.: 19/403,117

(22) Filed: Nov. 27, 2025

Related U.S. Application Data
(63) Continuation-in-part of application No. 18/240,361, filed on Aug. 31, 2023, now Pat. No. 12,501,865.
Application No. 18/240,361 is a continuation of application No. PCT/CN2022/133041, filed on Nov. 19, 2022.

(30) Foreign Application Priority Data
Jun. 24, 2022 (CN) 202221613928.3

(51) Int. Cl. A01G 20/47; F04D 29/70

(52) U.S. Cl. CPC A01G 20/47; F04D 29/703

(57) ABSTRACT

An air blowing device, including an air duct portion, a motor assembly arranged inside the air duct portion, a fan assembly driven by the motor assembly, a mounting portion located at a rear end of the air duct portion for mounting a battery pack, a control assembly connected to the motor assembly, a grip portion arranged at a top of the air blowing device, and a switch assembly arranged on the grip portion. The battery pack is disposed at a bottom of the grip portion. The switch assembly is connected to the control assembly. The switch assembly is configured to control an operation of the motor assembly through the control assembly. The control assembly is housed in the mounting portion.

### CROSS-REFERENCE TO RELATED APPLICATIONS

The present application is a continuation-in-part application of U.S. Patent Application No. 18/240,361, filed on August 31, 2023, which is a continuation-application of International (PCT) Patent Application No. PCT/CN2022/133041 filed on November 19, 2022, which claims foreign priority to Chinese Patent Application No. 202221613928.3, filed on June 24, 2022, the contents of which are herein incorporated by reference in their entireties.

### TECHNICAL FIELD

The present disclosure relates to the field of garden tools, and in particular to an air blowing device.

### BACKGROUND

An air blowing device may be a type of gardening equipment in which a motor drives a fan to rotate at high speed to draw outside air into the housing, pressurize it, and then blow it outward. The air blowing device may be widely used in home operations, such as leaf removal. The air blowing device may include a longitudinally extending housing, a motor assembly arranged inside the housing, a fan assembly connected to the motor assembly, an air inlet opened at an end of the housing and an air outlet opened at the other end of the housing. Area of the air inlet in the related art may be relatively small, resulting in less air intaken into the air blowing device, thus affecting the efficiency of the air blowing device. In addition, the air inlet of the related art may be integrated in the housing. After a long period of work, foreign particles accumulated in the air inlet may be hard to be cleaned.

Therefore, the air blowing device needs to be improved to overcome the shortcomings in the related art.

### SUMMARY OF THE DISCLOSURE

One embodiment of the present disclosure targeted at the current technical problems may be performed as follows: an air blowing device, including: an air duct portion, a motor assembly arranged inside the air duct portion, a fan assembly driven by the motor assembly, a mounting portion located at a rear end of the air duct portion for mounting a battery pack, a control assembly connected to the motor assembly, a grip portion arranged at a top of the air blowing device, and a switch assembly arranged on the grip portion. The battery pack is disposed at a bottom of the grip portion. The switch assembly is connected to the control assembly. The switch assembly is configured to control an operation of the motor assembly through the control assembly. The control assembly is housed in the mounting portion.

Another air blowing device may further be provided according to some embodiments of the present disclosure. The air blowing device includes: an air duct portion, a motor assembly arranged inside the air duct portion, a fan assembly driven by the motor assembly, a mounting portion located at a rear end of the air duct portion, a control assembly connected to the motor assembly. The mounting portion and the air duct portion are spaced apart from each other. The air blowing device includes an air filter arranged between the mounting portion and the air duct portion. The air blowing device further includes two sub-shells. The two sub-shells are combined with each other symmetrically about a central plane to form a housing of the air blowing device. The air filter is arranged between the two sub-shells. The control assembly is housed in the mounting portion.

### BRIEF DESCRIPTION OF THE DRAWINGS

The following drawings may provide further details to describe some embodiments of the present disclosure.

FIG. 1 is the perspective view of the overall structure of an air blowing device.

FIG. 2 is the schematic view of the air blowing device shown in FIG. 1 from a different angle, where a battery pack is removed.

FIG. 3 is the sectional view of the air blowing device shown in FIG. 1, where the battery pack is removed.

FIG. 4 is the perspective view of an air filter in the air blowing device shown in FIG. 1.

FIG. 5 is an enlarged schematic view of an area A in FIG. 3 according to an embodiment.

FIG. 6 is an enlarged schematic view of the area A in FIG. 3 according to another embodiment.

### DETAILED DESCRIPTION

The present disclosure may be described in further details along with the drawings and some embodiments.

The terms used to explain the present disclosure are only for the purpose of describing particular embodiments and are not intended to set limits on the present disclosure. Terms, such as “above”, “below”, “front”, “back”, “left”, “right”, are used to indicate relative positions or directions within the specific drawings and aim to facilitate and simplify the description of the present disclosure, rather than implying or dictating that the referred device/element must be located at the specific directions or be structured and performed in the specific directions, thus should not be understood as limitation to the present disclosure.

Furthermore, it is to be understood that the use of the term “substantially” herein, unless otherwise defined with respect to a specific context, with respect to a numeric quantity or otherwise quantifiable relationship, e.g., perpendicularity or parallelism, is to be understood as indicating that quantity +-10%. Thus, for example, lines that are substantially perpendicular to one another may be at angles between 81° and 99° to one another. In a further example, dimensions that are substantially between 1 mm and 3 mm, for example, may range from 0.9 mm to 3.3 mm. In another example, an angle that is substantially in the range of 1 to 1.1 radians may be between 0.9 radians and 1.21 radians.

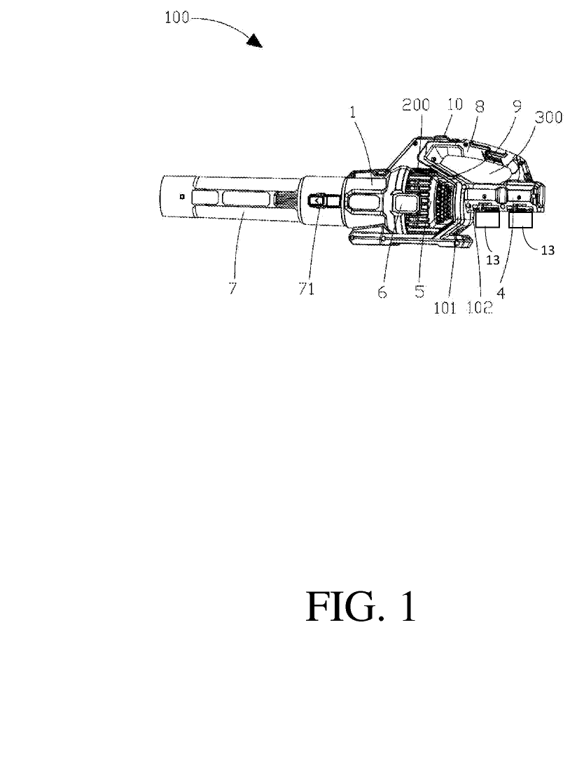

As shown in FIG. 1 to FIG. 3, according to the present disclosure, an air blowing device 100 may be provided. The air blowing device 100 may be widely used in technical fields, including but not limited to horticulture. The air blowing device 100 may include an air duct portion 1 extending along a front-rear direction, a motor assembly 2 arranged inside the air duct portion 1, a fan assembly 3 driven by the motor assembly 2, a control assembly 20 connected to the motor assembly 2, a mounting portion 4 located at a rear end of the air duct portion 1 for mounting a battery pack 13, a connecting portion 9 connecting the air duct portion 1 with the mounting portion 4, an air pipe 7 arranged at a front end of the air duct portion 1, a grip portion 8 arranged at a top of the air blowing device 100, and a switch assembly 10 arranged on the grip portion 8. The battery pack 13 is disposed at a bottom of the grip portion 8. The mounting portion 4 and the air duct portion 1 may be spaced apart from each other and cooperatively define an opening space 200. The opening space 200 may increase the amount of air intaken into the air blowing device 100. Air at an outside of the air blowing device 100 may flow into the air blowing device 100 through the opening space 200. The intaken air may further enter, driven by the motor assembly 2 and the fan assembly 3, the air duct portion 1, and may be blown out of the air blowing device 100 after being pressurized by the motor assembly 2 and the fan assembly 3.

In the present embodiment, two sub-shells 101 and 102 may combine with each other to form a housing of the air blowing device, and the two sub-shells 101 and 102 are symmetrical to each other, about a central plane.

In the present embodiment, the air duct portion 1 may define an air inlet 11 located near the opening space 200 and an air outlet 12 located away from the opening space 200. The motor assembly 2 and the fan assembly 3 may both be located between the air inlet 11 and the air outlet 12.

As shown in FIG. 1, given that a side of the air duct portion 1 is the front and a side of the mounting portion 4 is the rear, the air pipe 7, extending forward from the front end of the air duct portion 1, may be detachably arranged with the air duct portion 1 through a snap assembly 71.

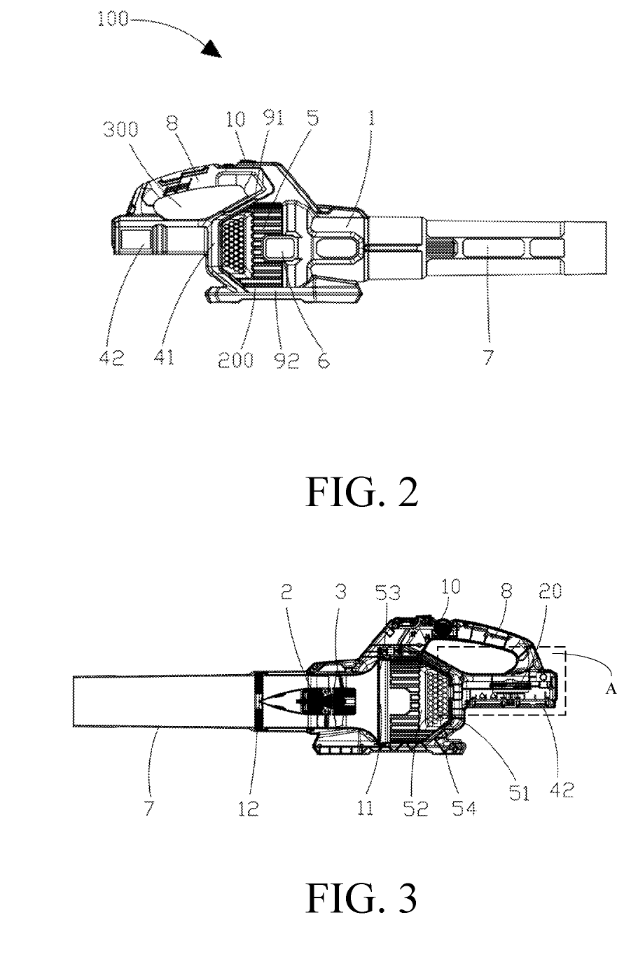

As shown in FIG. 2, given that a side of the grip portion 8 is the top and the opposite side of the grip portion 8 is the bottom, the connecting portion 9 may include a first connecting part 91 disposed at a top part of the connecting portion 9 and a second connecting part 92 disposed at a bottom part of the connecting portion 9. The opening space 200 may be defined by the first connecting part 91, the second connecting part 92, the air duct portion 1, and the mounting portion 4 cooperatively. As the opening space 200 may be located at each of two sides of the central plane, the air at the outside of the air blowing device 100 may flow into the air blowing device 100 through the opening space 200 on each of the two sides.

In the present embodiment, an end of the grip portion 8 may connect to the first connecting part 91, and the other end of the grip portion 8 may connect to the mounting portion 4. A space 300 may be defined by the grip portion 8, the first connecting part 91, and the mounting portion 4, cooperatively. A user may conveniently grasp the grip portion 8 by putting fingers through the space 300.

As shown in FIG. 3, the switch assembly 10 may be located at a top of the grip portion 8 and may connect to the control assembly 20 and may control an operation of the motor assembly 2 through the control assembly 20. The switch assembly 10 may facilitate the user to control and adjust an output parameter of the air blowing device 100.

In the present embodiment, the mounting portion 4 may include a mounting panel 41 extending along an up-down direction and a mounting base 42 extending from an end face of the mounting panel 41 in a direction away from the air duct portion 1. The grip portion 8 is connected to a rear end of the mounting base 42, and the connecting portion 9 is connected to the mounting panel 41. The battery pack 13 may be detachably arranged at the mounting base 42, and the air blowing device 100 may be powered by the battery pack 13.

In the present embodiment, the control assembly 20 may be housed in the mounting portion 4. Furthermore, the control assembly 20 may be housed inside the mounting base 42. In this way, through arranging the grip portion 8 at a top portion of the air blowing device 100 and the control assembly 20 within the mounting portion 4, an overall structure of the air blowing device 100 may be relatively compact, thereby realizing an efficient and space-saving layout.

As shown in FIG. 1 to FIG. 3, the air blowing device 100 may include an air filter 5 fixedly arranged between the mounting portion 4 and the air duct portion 1, and air filter 5 may be received in and completely fill the opening space 200, and the air at the outside of the air blowing device 100 may enter the opening space 200 through the air filter 5. By receiving the air filter 5 in the opening space 200, any foreign particle may be effectively prevented from entering an interior of the air duct part 1, without sacrificing the amount of air intaken into the air blowing device 100, and thus the service life of the air blowing device 100 may be extended. Due to a detachable structure, the air filter 5 may be easily detached from the air blowing device 100 and cleaned after being used for a long time.

In the present embodiment, the air filter 5 may be compatible with the opening space 200 as a shape of the air filter 5 may match to a surface of the opening space 200 receiving the air filter 5.

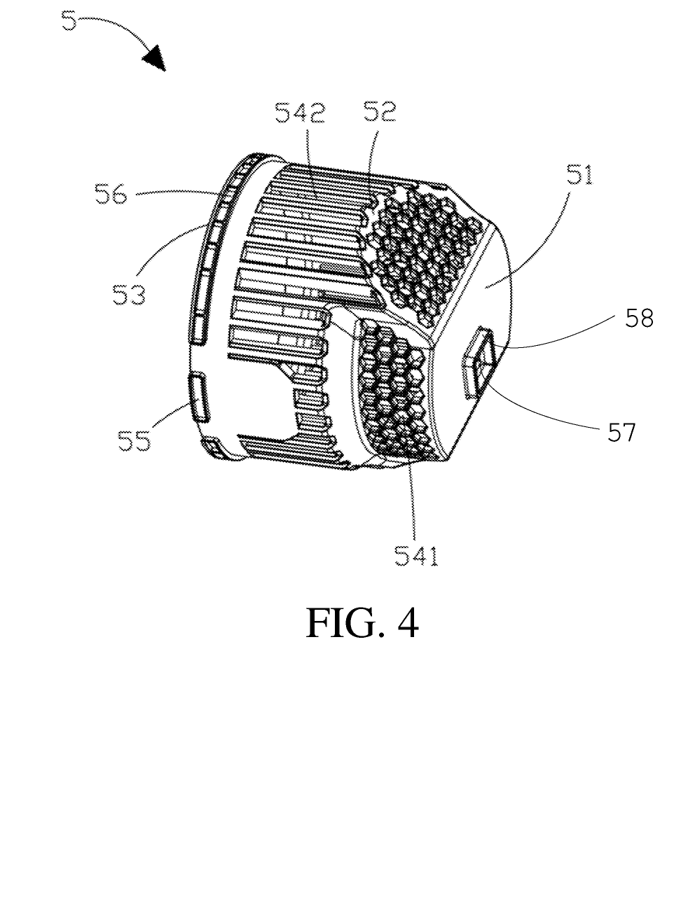

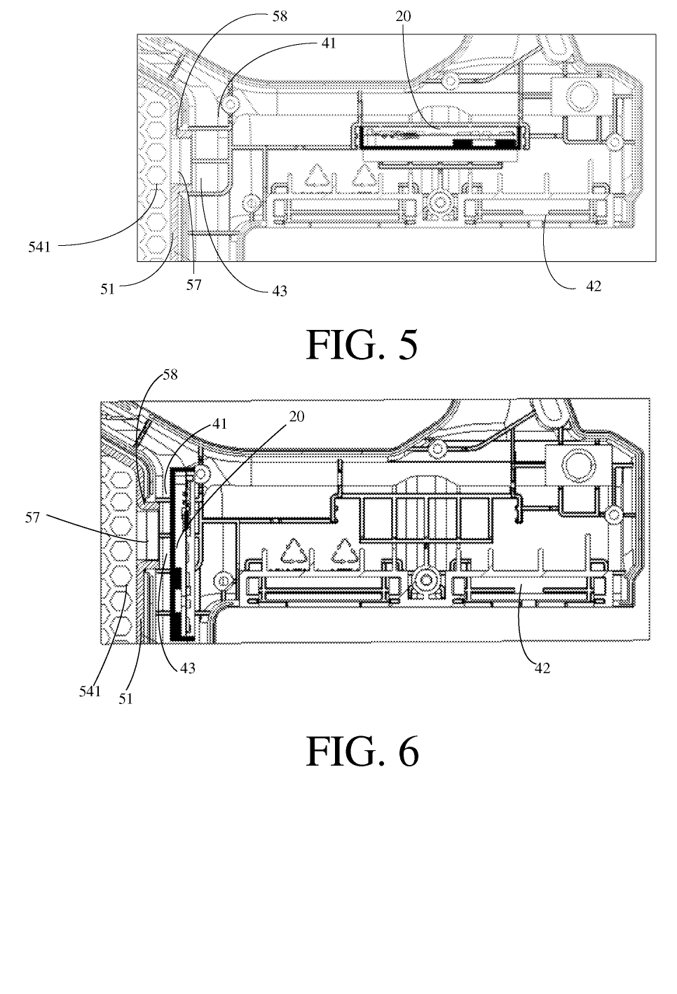

As shown in FIG. 4, the air filter 5 may include a base 51 attached to the mounting panel 41, a side wall 52 protruding from an outer periphery of the base 51 toward the air duct portion 1, an opening 53 defined by the side wall 52, at least one passage 54 extending through the side wall 52, and a first snap portion 56 located at an outer periphery of the side wall 52 and adjacent to the opening 53. The opening 53 may be located at an end of the side wall 52, while the base 51 may be located at the other end of the side wall 52. The air at the outside of the air blowing device 100 may enter the air filter 5 through the at least one passage 54 and may exit the air filter 5 through the opening 53. The air filter 5 may define a heat dissipation hole 57 penetrating the base 51. An interior of the air filter 5 may be in communication with an interior of the mounting portion 4 through the heat dissipation hole 57. The air filter 5 may further include an airflow guiding rib 58 extending toward a rear end of the air blowing device 100 from the heat dissipation hole 57. As shown in FIG. 5, the airflow guiding rib 58 may extend into the mounting panel 41 of the mounting portion 4. The mounting panel 41 may define a heat dissipation opening 43. The airflow guiding rib 58 may be received in the heat dissipation opening 43. The heat dissipation opening 43 may be in communication with the heat dissipation hole 57. The control assembly 20 may be housed or disposed in the mounting base 42. The control assembly 20 may extend substantially along the front-rear direction. An extension direction of the control assembly 20 may be substantially perpendicular to an extension direction of the base 51.

extending toward a rear end of the air blowing device 100 from the heat dissipation hole 57. As shown in FIG. 5, the airflow guiding rib 58 may extend into the mounting panel 41 of the mounting portion 4. The mounting panel 41 may define a heat dissipation opening 43. The airflow guiding rib 58 may be received in the heat dissipation opening 43. The heat dissipation opening 43 may be in communication with the heat dissipation hole 57. The control assembly 20 may be housed or disposed in the mounting base 42. The control assembly 20 may extend substantially along the front-rear direction. An extension direction of the control assembly 20 may be substantially perpendicular to an extension direction of the base 51.

In some embodiments, a projection of the control assembly 20 along the front-rear direction onto a plane where the base 51 is located may be at least partially located within the base 51. In some embodiments, the projection of the control assembly 20 along the front-rear direction onto the plane where the base 51 is located may be entirely located within the base 51. In some embodiments, the projection of the control assembly 20 along the front-rear direction onto the plane where the base 51 is located may at least partially overlap with the heat dissipation hole 57.

In this way, a rear end of the air filter 5 may be close to the mounting base 42. When external air enters the air filter 5, a negative pressure may be generated at the heat dissipation hole 57, which further results in a suction effect at the heat dissipation hole 57, thereby allowing heat generated by the operation of the control assembly 20 to be drawn away through the heat dissipation hole 57 and thus cooling the control assembly 20.

In some embodiments, as shown in FIG. 6, the control assembly 20 may be housed or disposed in the mounting panel 41. The control assembly 20 may extend substantially along the up-down direction and an extension direction of the control assembly 20 may be substantially parallel to an extension direction of the base 51. In this way, the control assembly 20 may be close to the heat dissipation hole 57, thereby achieving a good heat dissipation performance.

In the present embodiment, the opening 53 may be located inside the air inlet 11 so that air discharged from the opening 53 may directly enter the air duct portion 1 through the air inlet 11, and the efficiency of the air blowing device 100 may be effectively enhanced.

In the present embodiment, the at least one passage 54 may include a plurality of first passages 541 located near the mounting portion 4 and a plurality of second passages 542 located near the air duct portion 1. Area of opening of each of the plurality of first passages 541 may be smaller than area of opening of each of the plurality of second passages 542. Specifically, the plurality of first passages 541 may be arranged in shape of honeycomb, while each of the plurality of second passages 542 may be defined into an elongated hole extending along the front-rear direction. The plurality of second passages 542 may be arranged at intervals along the outer periphery of the side wall 52. Defining the at least one passage 54 into two different shapes may improve appearance of air filter 5 aesthetically. As shown in FIG. 1 and FIG. 2, a circumferential diameter of a part of the air filter 5 where the plurality of first passages 541 are defined may gradually decrease from a side of the plurality of first passages 541 toward a side of the base 51. In this way, the first passages 541 may be configured to converge toward the base 51, which facilitates an air-gathering effect within the first passages 541, thereby generating a high negative pressure that enhances the suction effect at the heat dissipation hole 57.

Furthermore, the first snap portion 56 may be arranged to occupy the entire outer periphery of the side wall 52. The air duct portion 1 may have a second snap portion (not labeled) corresponding to the first snap portion 56. The air filter 5 may be installed to the air duct portion 1 by snapping the first snap portion 56 with the second snap portion (not labeled).

As shown in FIG. 1 and FIG. 2, the air blowing device 100 may further include at least one connecting block 6, configured to connect the air duct portion 1 to the air filter 5. In the present embodiment, the number of the at least one connecting block 6 may be two. The two connecting blocks 6 may be located on opposite sides of a circumference of the air duct portion 1. Specifically, the air filter 5 may include a third snap portion 55 extending in a direction away from the opening 53 from the outer periphery of the side wall 52, i.e., extending outward from the outer periphery of the side wall 52 of the air filter 5, and the connecting block 6 may be snapped with the third snap portion 55.

Furthermore, the at least one connecting block 6 may be integrally formed on the air duct portion 1.

By receiving the air filter 5 inside the opening space 200, foreign particles may be prevented from entering the interior of the air duct portion 1, without sacrificing the amount of air intaken into the air blowing device 100, and thus the service life of the air blowing device 100 may be extended. Due to a detachable structure, the air filter 5 may be easily detached from the air blowing device 100 and cleaned after being used for a long time.

The above-mentioned embodiments may illustrate only some implementations of the present disclosure. Any ordinary skilled in the art may easily understand that various alternatives may be performed without departing from concept and extent of the present disclosure. Therefore, the scope of the present disclosure shall be subject to the claims.

1. An air blowing device, comprising: an air duct portion, a motor assembly arranged inside the air duct portion, a fan assembly driven by the motor assembly, a mounting portion located at a rear end of the air duct portion for mounting a battery pack, a control assembly connected to the motor assembly, a grip portion arranged at a top of the air blowing device, and a switch assembly arranged on the grip portion;
wherein the battery pack is disposed at a bottom of the grip portion, the switch assembly is connected to the control assembly, the switch assembly is configured to control an operation of the motor assembly through the control assembly, and the control assembly is housed in the mounting portion.

2. The air blowing device according to claim 1, further comprising an air filter,
wherein the mounting portion and the air duct portion are spaced apart from each other, and the air filter is arranged between the mounting portion and the air duct portion.

3. The air blowing device according to claim 2, further comprising a connecting portion,
wherein the mounting portion and the air duct portion cooperatively define an opening space, the connecting portion comprises a first connecting part disposed at a top part of the connecting portion, a second connecting part disposed at a bottom part of the connecting portion, and the opening space is defined by the first connecting part, the second connecting part, the air duct portion, and the mounting portion cooperatively; and
the air filter is received in and fills the opening space.

4. The air blowing device according to claim 2, wherein the air filter comprises a base, a side wall protruding from an outer periphery of the base toward the air duct portion, at least one passage extending through the side wall, and an opening defined by the side wall.

5. The air blowing device according to claim 4, wherein the air filter defines a heat dissipation hole penetrating the base, and an interior of the air filter is in communication with an interior of the mounting portion through the heat dissipation hole.

6. The air blowing device according to claim 5, wherein the air filter further comprises an airflow guiding rib extending toward a rear end of the air blowing device from the heat dissipation hole, and the airflow guiding rib extends into a mounting panel of the mounting portion.

7. The air blowing device according to claim 6, wherein the mounting panel defines a heat dissipation opening, the airflow guiding rib is received in the heat dissipation opening, and the heat dissipation opening is in communication with the heat dissipation hole.

8. The air blowing device according to claim 4, wherein a projection of the control assembly along a front-rear direction onto a plane where the base is located is at least partially located within the base.

9. The air blowing device according to claim 5, wherein a projection of the control assembly along a front-rear direction onto a plane where the base is located at least partially overlaps with the heat dissipation hole.

10. The air blowing device according to claim 4, wherein the at least one passage comprises a plurality of first passages near the mounting portion and a plurality of second passages near the air duct portion, area of opening of each of the plurality of first passages is smaller than area of opening of each of the plurality of second passages.

11. The air blowing device according to claim 10, wherein the plurality of first passages are defined in shape of honeycomb, each of the plurality of second passages is defined into an elongated hole extending along the front-rear direction, and a circumferential diameter of a part of the air filter where the plurality of first passages are defined gradually decreases from a side of the plurality of first passages toward a side of the base.

12. The air blowing device according to claim 2, further comprising two sub-shells,
wherein the two sub-shells are combined with each other symmetrically about a central plane to form a housing of the air blowing device, and the air filter is arranged between the two sub-shells.

13. The air blowing device according to claim 2, further comprising at least one connecting block, configured to connect the air duct portion with the air filter.

14. The air blowing device according to claim 13, wherein the number of the at least one connecting block is two and the at least one connecting block are located on opposite sides of a circumference of the air duct portion.

15. The air blowing device according to claim 13, wherein the air filter comprises a third snap portion extending outward from an outer periphery of a side wall of the air filter, the connecting block is snapped with the third snap portion, and the connecting block is integrally formed on the air duct portion.

16. An air blowing device, comprising: an air duct portion, a motor assembly arranged inside the air duct portion, a fan assembly driven by the motor assembly, a mounting portion located at a rear end of the air duct portion, and a control assembly connected to the motor assembly;
wherein the mounting portion and the air duct portion are spaced apart from each other, and the air blowing device comprises an air filter arranged between the mounting portion and the air duct portion;
wherein the air blowing device further comprises two sub-shells, the two sub-shells are combined with each other symmetrically about a central plane to form a housing of the air blowing device, and the air filter is arranged between the two sub-shells;
wherein the control assembly is housed in the mounting portion.

17. The air blowing device according to claim 16, wherein the air filter comprises a base, a side wall protruding from an outer periphery of the base toward the air duct portion, at least one passage extending through the side wall, an opening defined by the side wall, and a heat dissipation hole;
an interior of the air filter is in communication with an interior of the mounting portion through the heat dissipation hole.

18. The air blowing device according to claim 17, wherein the mounting portion comprises a mounting panel expanded along an up-down direction and a mounting base extended from an end face of the mounting panel in a direction away from the air duct portion.

19. The air blowing device according to claim 18, wherein the control assembly is housed in the mounting base, the control assembly extends substantially along a front-rear direction and an extension direction of the control assembly is substantially perpendicular to an extension direction of the base.

20. The air blowing device according to claim 18, wherein the control assembly is housed in the mounting panel, the control assembly extends substantially along the up-down direction and an extension direction of the control assembly is substantially parallel to an extension direction of the base.
